(19) United States
(12) Patent Application Publication
(10) Pub. No.: US 2009/0010660 A1
(43) Pub. Date: Jan. 8, 2009

(54) Developing Device of Electrographic Printing Apparatus, Non-Image-Region Toner Removing Device, Electrographic Printing Apparatus Using the Same, Electrographic Printing Method, and Method of Producing Glass Plate or Ceramic Plate

(75) Inventors: Tomoaki Okada, Hiroshima (JP); Toshihiko Kawanami, Hiroshima (JP); Tomohiro Fujii, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: Mitsubishi Heavy Industries, Ltd., TOKYO (JP)

(21) Appl. No.: 12/087,111

(22) PCT Filed: Jun. 12, 2007
(86) PCT No.: PCT/JP2007/061815

§ 371 Date: Jun. 26, 2008

(30) Foreign Application Priority Data
Jun. 13, 2006 (JP) 2006-163660

(51) Int. Cl. G03G 15/08

(52) U.S. Cl. 399/30

(57) ABSTRACT

A developing device for an electrographic printing apparatus provided has stable performance and improved printing quality. The developing device (5) for the electrographic printing apparatus (1) includes a supplying channel (37) having at least one stirring/delivering roller (27) for stirring and delivering a carrier and a toner charged by contacting the carrier; a developing roller (25) for supplying the toner adhered to the carrier to a supplying position of an electrostatic latent image on the photoreceptor (3), the developing member being disposed on a photoreceptor side of the supplying channel (37) and having a outer surface (47) that moves circumferentially and attracts the carrier; a collecting unit for collecting the carrier from the outer surface (47) at a position downstream of the supplying position in the moving direction of the outer surface (47); a collecting channel (39) for delivering the carrier collected at the collecting unit and circulating and supplying the carrier to the supplying channel (37); and a toner-concentration adjusting device (35), provided in the collecting channel (39), for adjusting the ratio of the carrier and the toner delivered through the collecting channel (39) to a predetermined value.

### TECHNICAL FIELD

The present invention relates to a developing device for an electrographic printing apparatus, a non-image-region toner removing device, an electrographic printing apparatus using the same, an electrographic printing method, and a method of producing a glass plate or a ceramic plate.

### BACKGROUND ART

Known electrographic printing apparatuses irradiate a uniformly charged photoreceptor with light from a light source, such as a laser or a light emitting diode (LED), in order to form an electrostatic latent image on the photoreceptor by neutralizing image regions that are irradiated with light and form an image by adhering a toner, which is charged to the same polarity as the photoreceptor, to the image regions. A known method of adhering a toner to a photoreceptor is the two-component development method described, for example, in Patent Documents 1 and 2. The two-component development method is a method of transferring a toner (particle size of 6 to 20 μm), which is adhered to the surface of a carrier, onto a photoreceptor by rubbing the surface of the photoreceptor with a magnetic brush of the carrier, which consists of magnetic particles (particle size of 40 to 120 μm), formed on a developing roller (magnet roller), which consists a multi-polar magnet, by means of a magnetic force.

In the developing device, a developer obtained by mixing the carrier and the toner at a predetermined ratio (T/C ratio) is stirred and delivered while the toner is charged by contact and adheres to the carrier by an electrostatic force. The carrier is adhered to the entire surface of a magnet roller by a magnetic force. A gap formed by a restricting blade regulates the amount of developer being applied at a constant rate. The developer is supplied through a nip between the photoreceptor and the development roller and is rubbed onto the photoreceptor. At this time, an electrostatic latent image corresponding to image data is formed on the photoreceptor; the toner is detached from the carrier in the image region by an electrostatic force generated by the potential difference with respect to the charged toner and is attached to the photoreceptor; and a repulsive force prevents the toner from adhering to the non-image region of the photoreceptor. In this way, a toner image (image) corresponding to the electrostatic latent image is formed on the photoreceptor.

The carrier from which the toner was detached in the image region returns into the developing device and is reused together with an externally supplied toner. The developer used in such a configuration must maintain a predetermined amount of toner (toner concentration) and a predetermined charge level for adhering the toner according to the electric potential of the electrostatic latent image in order to form a stable toner image. Since the toner concentration is determined on the basis of the distribution of the toner consumed in development and the toner supplied and the charge level of the toner is determined on the basis of friction when mixing the carrier and the toner, the developing device must sufficiently stirs the developer containing the toner and the carrier to make the toner concentration distribution uniform and to provide a saturated charge to the toner. In this way, the toner image is stabilized.

In the developed region, since the carrier is rubbed against the photoreceptor or carriers rub against each other, the toner adhered to the surface of the carrier by an electrostatic force detaches from the carrier, or the toner that does not have a sufficient charge level detaches from the carrier, and this toner adheres to the non-image regions of the photoreceptor, causing so-called “base fogging”. A method has been proposed in which the base fogging toner is removed by a carrier attracted to a magnet roller by a magnetic force.

Patent Document 1: Japanese Examined Patent Application, Publication No. HEI-3-194572

Patent Document 1: Japanese Examined Patent Application, Publication No. HEI-5-134540

### DISCLOSURE OF INVENTION

However, if those aspects described in Patent Documents 1 and 2 are applied to a wide-format (large) apparatus, the variation in the toner concentration of the developer becomes large, causing a problem in that a uniform image film thickness cannot be obtained.

For example, a known developing device 201 may have the configuration, illustrated in FIGS. 12 to 14. FIG. 12 is a longitudinal sectional view and FIG. 13 is a plan view of the developing device 201. The developing device 201 includes a stirring roller 202 having a plate blade, stirring/delivering rollers 203 and 204 having screw blades, a developing roller 205 with an embedded magnet, a development container 206, and a toner supplying device 207 for supplying toner. Depending on the shape of the development container 206 and the shape and orientation of the rollers, a large circulation flow 209, indicated by large arrows in the drawings, and flows 210a to 210e caused by supplying and stirring, indicated by small arrows, are generated.

Here, uniformity of the toner concentration is required for the developer 210a to be supplied to a developer gap 211 formed between the developing roller 205 and a photoreceptor 200. The developer 210a is obtained by mixing the used developer 210b and the concentration-adjusted developer 210c supplied by the circulation flow and is applied at a constant film thickness by a restriction blade 212. Therefore, the toner concentration of the developer 210a supplied to the developer gap 211 easily becomes low compared with a developer that has just been appropriately adjusted. The concentration-adjusted developer 210c is supplied along the large circulation flow 209 of the developer. However, when point C upstream of the circulation flow 209 and point D downstream of the circulation flow 209 are compared, the toner concentration at the downstream point D is lower. In other words, the inflow of fresh developer having an adjusted concentration is only at point C. By the time the developer reaches point D, the concentration decreases because the developer 210c is repeatedly mixed with the used developer 210b whose toner is consumed at the image region and is repeatedly supplied to the development region. In particular, the wider the developing device 201, the more significant the concentration difference between point C, which is the inlet of the circulation flow 209, and point D, which is the outlet.

When a wide-format apparatus is used, the apparatus is greatly affected by problems such as the changing toner concentration and the toner charge becoming insufficient depending on the response of the toner supply. First, when a toner concentration sensor 208 detects a decrease in toner concentration, toner is supplied by the toner supplying device 207. However, there is a time delay in supplying the developer having an appropriately adjusted concentration to the developer gap 211, and therefore, it is not possible to quickly respond to a local concentration change. The toner concentration of the used developer 210b differs depending on the type of image to be printed. In other words, the toner concentration hardly decreases at a plain printing region 214 (where no image is printed) (the decreases is equivalent to base fogging), but there is a significant decrease in the toner concentration in a solid image region 213 where toner is required for the entire region and a large amount of toner is consumed.

More specifically, an example of a case in which toner is supplied to the photoreceptor 200, which is shown in FIG. 14, the half on the point C side being the solid image region 213 and the other half on the point D side being the plain printing region 214, is described.

There is a significant decrease in the concentration of the toner contained in the used developer 210b in a region 210b-2 near the plain printing region 214 because the developer from a region 210b-1 upstream of the region 210b-2 is repeatedly supplied to the solid image region 213 with the toner already being consumed. However, since the developer delivered to the toner concentration sensor 208 is delivered by the circulation flow 209 after passing through the plain printing region 214, a decrease in the toner concentration is not detected, and thus, the toner concentration is not adjusted. For instance, even if supplementary toner from the toner supplying device 207 is supplied when there is a decrease in the toner concentration at the region 210b-2, there is a delay for the toner to reach the solid image region 213 through the circulation flow 209. Therefore, the film thickness of a solid image region 213b downstream of the circulation flow 209 becomes thinner compared with that of a solid image region 213a upstream of the circulation flow 209.

To speed up the response of the toner concentration control, the toner delivery speed and the toner supply position are adjusted to decrease the time required for the supplementary toner to reach the development region after being supplied. Consequently, the time required for stirring the supplied toner and the carrier is also reduced, causing insufficient charging of the toner. As a result, as the response of the toner concentration is improved, problems such as a fluctuation in the film thickness (image film thickness) of the toner that adheres to the photoreceptor 200 and base fogging occur. For this reason, there is a limit to the improvement of the response of toner concentration control. The fluctuation of the image film thickness caused by a change in concentration, as described above, is not a significant problem for a commercial printer that is used to print small (narrow) materials containing text information to be read by someone. However, it becomes a significant defect in industrial applications requiring a developing device having a width of more than one meter, and which are used for printing conductive patterns in which high accuracy is required in the film thickness.

A known developing apparatus requires the supplying channel to have two functions: toner charging and uniform supply in the width direction. Accordingly, to perform such functions appropriately for each toner, experiments (cut and dry) are repeated to appropriately set the shape, angle, pitch, roller speed, and so on of the screw blade of the stirring/delivering roller. Therefore, development costs increase, placing a large burden on the development of small lots of large apparatuses.

For an apparatus in which base fogging toner is circulated by a magnet roller and removed by the carrier, the removed toner is accumulated on the carrier and may be transferred onto the photoreceptor again. In other words, there is a problem in that the printing quality may decrease.

The present invention has been conceived in light of the above-described problems. Accordingly, it is an object of the present invention to provide a developing device and a non-image-region toner removing-device of an electrographic printing apparatus, as well as an electrographic printing apparatus, which is required in industrial production facilities, using the same, that are capable of providing a wide and uniform image film thickness.

To solve the above-described problems, the present invention provides the following solutions. In other words, a first aspect of the present invention provides a developing device for an electrographic printing apparatus including a supplying channel having at least one delivering roller for stirring and delivering a carrier and a toner charged by contacting the carrier; a developing member for supplying the toner adhered to the carrier to a supplying position of an electrostatic latent image on a photoreceptor, the developing member being disposed on the photoreceptor side of the supplying channel and having a supplying surface that moves circumferentially and attracts the carriers; a collecting unit for collecting the carrier from the supplying surface at a position downstream of the supplying position in the moving direction of the supplying surface; a collecting channel for delivering the carrier collected at the collecting unit and circulating and supplying the carrier to the supplying channel; and a toner-concentration adjusting device, provided in the collecting channel, for adjusting the ratio of the carrier and the toner delivered through the collecting channel to a predetermined value.

According to this aspect, the carrier containing a decreased amount of toner after supplying the toner to the photoreceptor is collected from the supplying surface into the collecting channel in the collecting unit provided downstream of the supplying position of the photoreceptor. The carrier to toner ratio of the carrier collected in the collecting unit is adjusted to a predetermined value by the toner-concentration adjusting device while the carrier is delivered through the collecting channel. In other words, an amount of toner corresponding to the amount of the toner transferred to the photoreceptor is supplied. With the carrier to toner ratio adjusted to a predetermined value, the carrier is supplied from the collecting channel to the supplying channel again and is stirred and delivered.

In this way, since the carrier containing a decreased amount of toner after supplying the toner to the photoreceptor is not directly returned to the supplying channel of the carrier, a change, such as a decrease, in the toner concentration near the supplying surface can be prevented. Since the carrier is supplied to the supplying channel with the toner concentration adjusted to a predetermined value by the toner-concentration adjusting device, the toner and the carrier can be sufficiently stirred while they are delivered through the supplying channel, and thus the toner can be sufficiently charged. In this way, since the toner is supplied from the developing device to the photoreceptor while having a predetermined level of charge and without changing the concentration, stable performance is achieved even for wide-format apparatuses, and a uniform image film thickness is provided. In particular, this is effective for forming conductive patterns for industrial products.

In the above-described aspect, the carrier and the toner may be stirred while being delivered through the collecting channel.

In this way, since the carrier and the toner are stirred while being delivered through the collecting channel, the toner can be charged by contact before it is supplied to the supplying channel. Accordingly, the toner can be reliably charged to a predetermined level. In this way, functions can be separated in such a manner that the toner is charged in the collecting channel and the supplying channel functions exclusively to uniformly supply toner in the width direction. Therefore, the functional design of the apparatus is simplified, and development costs can be reduced.

In the above-described aspect, the collecting unit may include a blade for rubbing off the carrier, the blade being in contact with the supplying surface.

In this way, since the collecting unit includes a blade, in contact with the supplying surface, for rubbing off the carrier, the carrier containing a decreased amount of toner after supplying the toner to the photoreceptor can be reliably collected from the supplying surface into the collecting channel.

According to the above-described aspect, the toner-concentration adjusting device includes a toner-concentration adjusting device for measuring the toner concentration and a toner supplying device for supplying the toner.

According to this developing device, the concentration of the toner contained in the carrier delivered through the collecting channel is measured by the toner-concentration adjusting device, and the amount of toner required for achieving a predetermined concentration is calculated. The calculated amount of toner is supplied by toner supplying device. In this way, the ratio of the carrier and the toner delivered through the collecting channel can be reliably maintained at a predetermined-value.

In the above-described aspect, the collecting channel may be divided into a plurality of sections in the width direction.

In this way, since the collecting channel is divided into a plurality of sections in the width direction, a toner-concentration adjusting device is provided for each section. Since the range to be adjusted by each toner-concentration adjusting device becomes small, the accuracy of concentration adjustment can be improved. In this way, since toner having a constant concentration is supplied from the developing device to the photoreceptor, stable performance can be achieved, and the printing quality can be improved. Moreover, since the toner is stirred and delivered in each section, stress applied to the toner can be reduced, and the durability of the toner can be improved. In other words, when a large amount of toner is delivered through a single channel, toner is placed on top of other toner, causing the toner in the lower layer to be compressed and condensed. As a result, degradation of the toner over time, such as a decrease in the fluidity of the toner, may easily occur. However, by dividing into sections according to the width of the developing device, the delivery amount can be set constant, and even when the width of the developing device is large, the durability of the toner can be maintained at a level equivalent to that of a developing device having a small width, thus simplifying the design and making it easy to maintain durability. By setting the size of the divided sections as a standard size, the design and development costs of the apparatus using common parts can be reduced by producing an apparatus having a width that is an integral multiple of the standard size.

A second aspect of the present invention provides a non-image-region toner removing device of an electrographic printing apparatus including a carrier supplying channel for delivering a removing carrier, the carrier supplying channel being provided downstream of a developing device for supplying a toner to an electrostatic latent image forming an image region on a photoreceptor; a removing member for removing a toner adhered to a non-image region on the photoreceptor at a removing position using the removing carrier, the removing member being disposed on the photoreceptor side of the removing-carrier supplying channel and having a removing surface that moves circumferentially and attracts the removing carrier; a removing-carrier collecting unit for collecting the removing carrier from the removing surface at a position downstream of the removing position in the moving direction of the removing surface; a removing-carrier collecting channel for delivering the removing carrier collected at the removing-carrier collecting unit and circulating and supplying the removing carrier to the carrier supplying channel; and a carrier cleaning unit, provided in the removing-carrier collecting channel, for removing the toner collected from the removing carrier delivered through the removing-carrier collecting channel.

According to this aspect, the removing carrier that has removed the base fogging toner adhered to the non-image region of the photoreceptor by being attracted to the removing surface of the removing member is collected from the removing surface into the removing-carrier collecting channel in the removing-carrier collecting unit provided downstream of the removing position. The toner adhered to the removing carrier collected into the removing-carrier collecting unit is removed by the carrier cleaning unit while being delivered through the removing-carrier collecting channel, and the carrier is supplied to the carrier supplying channel again. In this way, since the carrier cleaning unit removes the adhered toner from the removing carrier with the base fogging toner removed and then circulates and supplies the carrier through the carrier supplying channel, the removing carrier approaches the photoreceptor without the toner adhered thereto. Therefore, the toner is reliably prevented from transferring the toner again from the removing carrier to the photoreceptor. In this way, stable and reliable removal of the base fogging toner can be carried out, and thus the printing quality can be improved. In particular, this is effective for forming conductive patterns for industrial products.

In the above-described aspect, the removing-carrier collecting unit may include a removing blade for rubbing off the removing carrier, the removing blade being in contact with the removing surface.

In this way, since the removing-carrier collecting unit includes a removing blade, in contact with the removing surface for rubbing off the removing carrier, the removing carrier with the toner adhered thereto can be reliably collected from the removing surface into the removing-carrier collecting channel.

A third aspect of the present invention provides an electrographic printing apparatus using the developing device according to the first aspect.

Since the electrographic printing apparatus according to this aspect uses a developing device capable of supplying toner having a predetermined level of charge and a constant concentration to a photoreceptor, stable performance can be achieved, and the printing quality can be improved. In particular, this is effective for forming conductive patterns for industrial products.

A fourth aspect of the present invention provides an electrographic printing apparatus using the non-image-region toner removing device according to the second aspect.

Since the electrographic printing apparatus according to this aspect uses a non-image-region toner removing device that is capable of stable and reliable removal of base fogging toner, base fogging of printed materials can be prevented, and high printing quality can be maintained. In particular, this is effective for forming conductive patterns for industrial products.

A fifth aspect of the present invention provides an electrographic printing apparatus using the developing device according to the first aspect and the non-image-region toner removing device according to the second aspect.

Since the electrographic printing apparatus according to this aspect uses a developing device that is capable of supplying a toner having a predetermined level of charge and a constant concentration to the photoreceptor and a non-image-region toner removing device that is capable of stably and reliably removing base fogging toner, stable performance is achieved, base fogging on printing materials is prevented, and the printing quality is improved. In particular, this is effective for forming conductive patterns for industrial products.

A sixth aspect of the present invention provides an electrographic printing method including a stirring and delivering step of stirring and delivering a carrier and a toner charged by contacting the carrier using at least one delivering roller; a supplying step of attracting the carrier delivered in the stirring and delivering step and supplying the toner adhered to the carrier to a supplying position of an electrostatic latent image on a photoreceptor using a developing member having a supplying surface that moves circumferentially; a collecting step of collecting the carrier from the supplying surface at a position downstream of the supplying portion in the moving direction of the supplying surface; a circulating and supplying step of delivering the carrier collected in the collecting step and circulating and supplying the carrier to the supplying channel; and a toner-concentration adjusting step of adjusting the ratio of the carrier and the toner delivered in the circulating and supplying step to a predetermined value.

In the electrographic printing method according to this aspect, the carrier containing a decreased amount of toner after supplying the toner to the photoreceptor is collected from the supplying surface at a position downstream of the supplying position of the photoreceptor and is circulated and supplied through the supplying channel. The carrier to toner ratio of the carrier collected in the collecting unit is adjusted to a predetermined value while being circulated and supplied; i.e., an amount of toner corresponding to the toner transferred to the photoreceptor is supplied. In this way, since the carrier containing a decreased amount of toner after supplying the toner to the photoreceptor is not directly returned to the supplying channel of the carrier, changes, such as a fluctuation in the toner concentration, near the supplying surface can be prevented. Since the collected carrier is supplied to the supplying channel after its carrier to toner ratio is adjusted to a predetermined value, the toner and the carrier are sufficiently stirred while being delivered through the supplying channel, and the toner is sufficiently charged. In this way, since a toner having a predetermined level of charge and a constant concentration is supplied to the photoreceptor, even when a wide-format apparatus is used, stable performance is achieved, and a uniform image film thickness can be provided.

A seventh aspect of the present invention provides a method of producing a glass plate or a ceramic plate by forming a pattern on the glass plate or the ceramic plate using an electrographic printing apparatus involving a stirring and delivering step of stirring and delivering a carrier and a toner charged by contacting the carrier using at least one delivering roller, and a supplying step of attracting the carrier delivered in the stirring and delivering step and supplying the toner adhered to the carrier to a supplying position of an electrostatic latent image on a photoreceptor using a developing member having a supplying surface that moves circumferentially, the method of producing a glass plate or a ceramic plate including a collecting step of collecting the carrier that passed the supplying position from the supplying surface; a circulating and supplying step of delivering the carrier collected in the collecting step and circulating and supplying the carrier to the supplying channel; and a toner-concentration adjusting step of adjusting the ratio of the carrier and the toner delivered in the circulating and supplying step to a predetermined value.

In this aspect, the carrier containing a decreased amount of toner after supplying the toner to the photoreceptor is collected from the supplying surface at a position downstream of the supplying position of the photoreceptor and is circulated and supplied through the supplying channel. The carrier to toner ratio of the carrier collected in the collecting unit is adjusted to a predetermined value while being circulated and supplied; i.e., an amount of toner corresponding to the toner transferred to the photoreceptor is supplied. In this way, since the carrier containing a decreased amount of toner after supplying the toner to the photoreceptor is not directly returned to the supplying channel of the carrier, changes, such as a fluctuation in the toner concentration, near the supplying surface can be prevented. Since the collected carrier is supplied to the supplying channel after its carrier to toner ratio is adjusted to a predetermined value, the toner and the carrier are sufficiently stirred while being delivered through the supplying channel, and the toner is sufficiently charged. In this way, since a toner having a predetermined level of charge and a constant concentration is supplied to the photoreceptor from the developing device, even when a wide-format apparatus is used, stable performance is achieved, and a uniform image film thickness can be provided. Therefore, even if the width of the printing material is large, the ratio of the carrier and the toner supplied to the electrostatic latent image on the photoreceptor is always maintained constant, regardless of place, time or the image pattern, and a glass plate or a ceramic plate having a pattern with a highly accurate film thickness can be provided. In this way, since a glass plate or a ceramic plate having a pattern with a highly accurate film thickness is obtained, in particular, when an electric circuit is formed of a conductive pattern, high-quality products with a small fluctuation in the electric signal characteristic, the thermal characteristic, and so on can be obtained.

An eighth aspect of the present invention is an electrographic printing method including a removing-carrier supplying step of delivering a removing carrier downstream of a developing device for supplying a toner to an electrostatic latent image forming an image region on a photoreceptor; a removing step of attracting the removing carrier delivered in the removing-carrier supplying step with a removing member having a removing surface that moves circumferentially and removing a toner adhered to a non-image region of the photoreceptor at a removing position using the removing carrier; a removing-carrier collecting step of collecting the removing carrier that passed the removing position from the removing surface; a removing-carrier circulating and supplying step of delivering the removing carrier collected in the removing-carrier collecting step and circulating and supplying the removing carrier to the removing-carrier supplying channel; and a carrier cleaning step of removing the toner from the removing carrier delivered in the removing-carrier circulating and supplying step.

In this aspect, since the removing carrier that has removed that toner adhered to the non-image region on the photoreceptor is collected from the removing surface to remove the adhered toner and is supplied again, the removing toner approaches the photoreceptor without the toner being adhered thereto. In this way, the toner can be reliably prevented from being transferred from the removing carrier to the photoreceptor again. In this way, stable and reliable removal of the base fogging toner can be performed, and thus, high printing quality can be maintained.

A ninth aspect of the present invention is an method of producing a glass plate or a ceramic plate by forming a pattern on the glass plate or the ceramic plate using an electrographic printing apparatus involving a removing-carrier supplying step of delivering a removing carrier downstream of a developing device for supplying a toner to an electrostatic latent image forming an image region on a photoreceptor, and a removing step of attracting the removing carrier delivered in the removing-carrier supplying step with a removing member having a removing surface that moves circumferentially and removing a toner adhered to a non-image region of the photoreceptor at a removing position using the removing carrier, the method of producing a glass plate or a ceramic plate including a removing-carrier collecting step of collecting the removing carrier that passed the removing position from the removing surface; a removing-carrier circulating and supplying step of delivering the removing carrier collected in the removing-carrier collecting step and circulating and supplying the removing carrier to the removing-carrier supplying channel; and a carrier cleaning step of removing the toner from the removing carrier delivered in the removing-carrier circulating and supplying step.

In this aspect, since the removing carrier that has removed that toner adhered to the non-image region on the photoreceptor is collected from the removing surface to remove the adhered toner and is supplied again, the removing toner approaches the photoreceptor without the toner being adhered thereto. In this way, the toner can be reliably prevented from being transferred from the removing carrier to the photoreceptor again. Since the toner adhered to the removing carrier is prevented from being transferred to the photoreceptor, a glass plate or a ceramic plate having a pattern without base fogging can be provided. In this way, since a glass plate or a ceramic plate having a pattern without base fogging is obtained, in particular, when an electric circuit is formed of a conductive pattern, high-quality products with less functional degradation involving electric noise and pressure resistance can be obtained.

According to the present invention, since a toner having a predetermined level of charge and a constant concentration is supplied to a photoreceptor, stable performance is achieved even for a wide-format product, and a uniform image thickness can be provided.

Since base fogging toner is removed in a stable and reliable manner, the printing quality can be improved.

### BRIEF DESCRIPTION OF DRAWINGS

FIG. 1 is a schematic view illustrating, in outline, the structure of an electrographic printing apparatus according to an embodiment of the present invention.

FIG. 2 is a sectional view illustrating, in outline, the structure of a developing device shown in FIG. 1.

FIG. 3 is a lateral sectional view illustrating the inner structure of a developing roller shown in FIG. 2.

FIG. 4 is a longitudinal sectional view illustrating, in outline, the structure of a toner removing device shown in FIG. 1.

FIG. 5 is a side view illustrating, in outline, the structure of the toner removing device shown in FIG. 4.

FIG. 6 is a sectional view illustrating, in outline, the structure of a developing device according to another embodiment.

FIG. 7 is a sectional view illustrating, in outline, the structure of a developing device according to another embodiment.

FIG. 8 is another sectional view illustrating, in outline, the structure of a developing device according to another embodiment.

FIG. 9 is a perspective view illustrating, in outline, a collecting channel shown in FIG. 8.

FIG. 10 is a cross-sectional view taken along line X-X in FIG. 9.

FIG. 11 is a perspective view illustrating stirring/delivering rollers 27 shown in FIG. 8.

FIG. 12 is a longitudinal sectional view illustrating, in outline, a possible known developing device.

FIG. 13 is a plan view of FIG. 12.

FIG. 14 is a plan view of FIG. 12.

### EXPLANATION OF REFERENCE SIGNS

1: electrographic printing apparatus
3: photoreceptor
5: developing device
7: non-image-region toner removing device
25: developing roller
27: stirring/delivering rollers
29: supplying roller
35: toner-concentration adjusting device
37: supplying channel
39: collecting channel
47: outer surface
49: blade
51: concentration sensor
53: toner supplying device
67: toner separating device
69: removing-carrier supplying channel
75: outer surface
77: removing blade
79: removing-carrier collecting channel

### BEST MODE FOR CARRYING OUT THE INVENTION

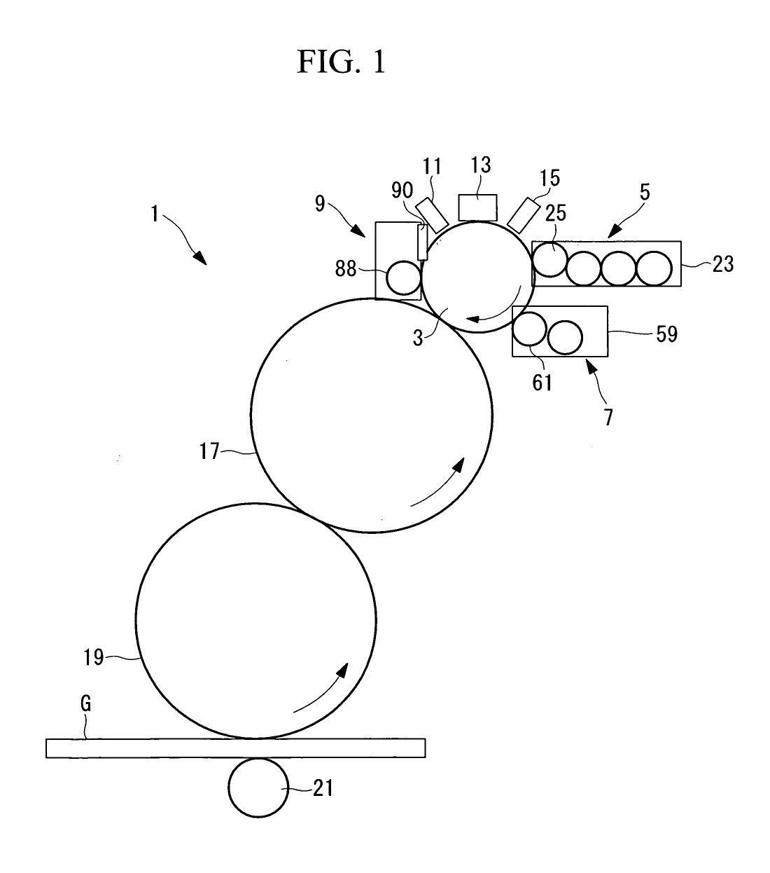

An electrographic printing apparatus 1 according to an embodiment of the present invention will be described below with reference to FIGS. 1 to 5.

FIG. 1 is a schematic view illustrating, in outline, the overall structure of an electrographic printing apparatus according to this embodiment.

The electrographic printing apparatus 1 prints a conductive pattern (metal wires) having a predetermined shape on a glass plate (plate glass) G.

The electrographic printing apparatus 1 includes a photoreceptor 3, a developing device 5, a non-image-region toner removing device 7, a cleaning device 9, a neutralizing device 11, a charging device 13, an exposure device 15, a first intermediate body 17, a second intermediate body 19, and a guiding roller 21.

The photoreceptor 3 is substantially cylindrical and is disposed in such a manner that it is rotationally driven around the center axis.

The surface of the photoreceptor 3 is formed of an organic photoconductor (OPC). The surface of the photoreceptor 3 may instead be formed of amorphous silicon (a-Si).

The developing device 5, the non-image-region toner removing device 7, the first intermediate body 17, the cleaning device 9, the neutralizing device 11, the charging device 13, and the exposure device 15 are disposed around the photoreceptor 3 in this order in the rotational direction.

The developing device 5 provides a toner, which is part of a two-component developer containing the toner and a carrier, to the photoreceptor 3.

The toner used in this embodiment is made by finely pulverizing a mixture of resin, silver powder, and glass powder. The resin may be, for example, a styrene resin or a styrene-acrylic resin having a pulverized particle diameter of approximately 10 to 20 μm.

It is preferable that an electrostatic charging agent be mixed with the toner. The glass powder functions as an adhesive for attaching the toner to the glass plate G.

The carrier comprises a magnetic material having cores made of a ferromagnetic material, such as ferrite or iron, and a surface coated with resin.

The two-component developer used in this embodiment contains approximately 6 wt % of toner relative to the carrier.

By stirring the toner and the carrier, the toner is charged by contact and adheres to the carrier by an electrostatic force.

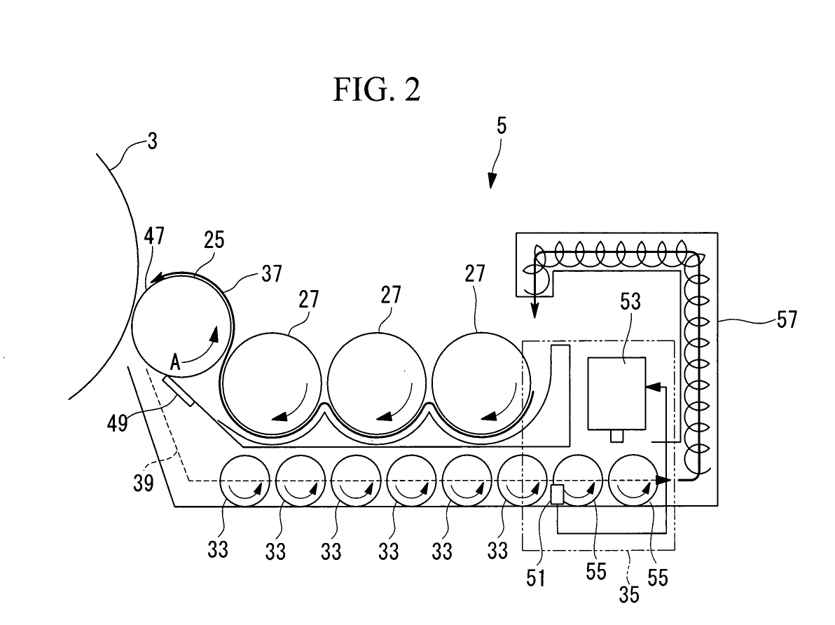

FIG. 2 is a schematic view illustrating, in outline, the overall structure of the developing device 5.

The developing device 5 includes a casing 23, a developing roller 25, a plurality of stirring/delivering rollers (delivering rollers) 27 having screw blades, a plurality of collecting rollers 33 that are screw-shaped or paddle-shaped, and a toner-concentration adjusting device 35.

The casing 23 is divided into upper and lower sections. In the upper section of the casing 23, the developing roller 25 and the stirring/delivering rollers 27 are disposed in this order from the photoreceptor 3 side to form a supplying channel 37.

The developing roller 25 and the stirring/delivering rollers 27 are attached in such a manner that the center axes are substantially parallel to the center axis of the photoreceptor 3.

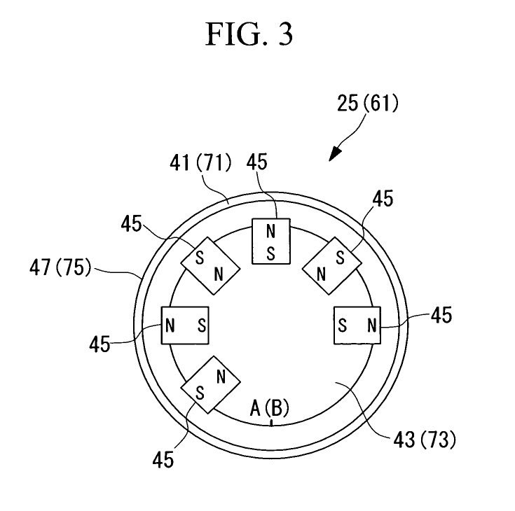

FIG. 3 is a lateral sectional view illustrating the inner structure of the developing roller 25.

The developing roller 25 is a so-called magnet roller and is disposed on the supplying channel 37 on the edge section closer to the photoreceptor 3 in such a manner that it protrudes toward the photoreceptor 3.

As shown in FIG. 3, the developing roller 25 is mainly formed of a substantially cylindrical sleeve 41 disposed on the outer circumference side and a magnetic-force forming unit 43 disposed inside the sleeve 41.

The sleeve 41 is attached to the magnetic-field forming unit 43 in a rotatable manner and rotates around the magnetic-field forming unit 43 by a driving force, which is not shown in the drawing.

As shown in FIG. 3, a plurality of permanent magnets 45 which are disposed along the axial direction is disposed on the magnetic-field forming unit 43 at certain intervals in the circumferential direction.

The plurality of permanent magnets 45 is disposed between the substantially seven-thirty position and the 3 o'clock position around the lateral cross-section of the magnetic-field forming unit 43 in the clockwise direction.

The sleeve 41 attracts the carrier on its outer surface (supplying surface) 47 by the magnetic force of the permanent magnets 45 and rotates in the counterclockwise direction.

A predetermined negative voltage, e.g., approximately −800 V, is applied to the sleeve 41.

When the sleeve 41 reaches a position A at the substantially 7 o'clock position, the magnetic force of the permanent magnets 45 does not act upon the carrier. Therefore, the carrier is no longer held by the sleeve 41 and falls due to gravity. In other words, a collecting unit according to the present invention is formed.

A blade 49 is disposed on the end section at the photoreceptor 3 side of the supplying channel 37 in such a manner that the tip contacts the sleeve 41 near the position A.

The plurality of collecting rollers 33 in the lower section of the casing 23 is disposed substantially parallel to the photoreceptor 3 to form a collecting channel 39.

The photoreceptor 3 side of the collecting channel 39 is positioned closer to the photoreceptor 3 than the position A and receives the carrier that falls from the position A or, in other words, collects the carrier.

The collecting rollers 33 deliver the collected carrier in a direction away from the photoreceptor 3.

The toner-concentration adjusting device 35 is disposed downstream of the collecting channel 39 in the carrier delivery direction.

The toner-concentration adjusting device 35 includes a concentration sensor (toner-concentration adjusting device) 51, a toner supplying device (toner supplying device) 53, and toner stirring/delivering rollers 55.

The concentration sensor 51 measures the toner concentration in the delivered carrier, i.e., the weight ratio (T/C ratio) of the carrier and the toner.

The toner supplying device 53 supplies an amount of toner required to achieve a predetermined T/C ratio, which is measured by the concentration sensor 51.

The toner stirring/delivering rollers 55 have function of stirring and delivering the toner supplied by the toner supplying device 53 together with the carrier.

At least one carrier delivering device 57 is provided on the edge section on the other side of the collecting channel 39 relative to the photoreceptor 3.

The carrier delivering device 57 is formed of, for example, a flexible screw and delivers the carrier with an adjusted T/C ratio from the collecting channel 39 to the supplying channel 37.

The carrier delivering device 57 also has a function of adhering the toner to the carrier by sufficiently charging the toner by generating friction by means of stirring the carrier and the toner, when delivering the carrier.

Next, the structure of the non-image-region toner removing device 7 will be described.

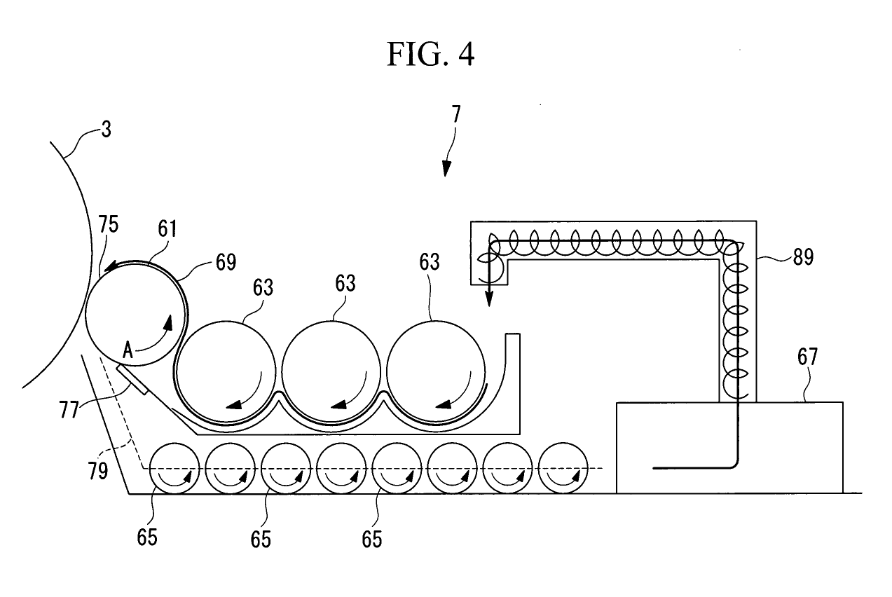

FIG. 4 is a schematic view illustrating, in outline, the overall structure of the non-image-region toner removing device 7.

The non-image-region toner removing device 7 includes a casing 59, a toner removing roller 61, a plurality of removing-carrier delivering rollers 63 that have screw blades, a plurality of removal/collecting rollers 65 that are screw-shaped or paddle-shaped, and a toner separating device (carrier cleaning unit) 67.

The casing 59 is divided into upper and lower sections. In the upper section of the casing 59, the toner removing roller 61 and the removing-carrier delivering rollers 63 are disposed in this order from the photoreceptor 3 side to form a removing-carrier supplying channel 69.

The toner removing roller 61 and the removing-carrier delivering rollers 63 are attached in such a manner that the center axes are substantially parallel to the center axis of the photoreceptor 3.

The toner removing roller 61 is a so-called magnet roller and is disposed on the removing-carrier supplying channel 69 on the edge section closer to the photoreceptor 3 in such a manner that it protrudes toward the photoreceptor 3.

Since the toner removing roller 61 has substantially the same structure as the developing roller 25, a drawing thereof is omitted and, instead, reference numerals of the related members are provided in parentheses in FIG. 3, and descriptions thereof are omitted.

The toner removing roller 61 is mainly formed of a substantially cylindrical removing sleeve 71 disposed on the outer circumference and a removing-magnetic-force forming unit 73 that is disposed inside the removing sleeve 71.

The removing sleeve 71 is attached to the removing-magnetic-force forming unit 73 in a rotatable manner and rotates around the removing-magnetic-force forming unit 73 by a driving force, which is not shown in the drawing.

The removing sleeve 71 attracts the removing carrier to its outer surface (removing surface) 75 by the magnetic force of the permanent magnets 45 and rotates in the counterclockwise direction.

When the removing sleeve 71 reaches a position B at the substantially 7 o'clock position, the magnetic force of the permanent magnets 45 does not act upon the removing carrier. Therefore, the removing carrier is no longer held by the sleeve 41 and falls due to gravity. In other words, a removing-carrier collecting unit according to the present invention is formed.

A removing blade 77 is disposed on the end section at the photoreceptor 3 side of the removing-carrier supplying channel 69 in such a manner that the tip contacts the removing sleeve 71 near the position B.

The plurality of removal/collecting rollers 65 in the lower section of the casing 59 is disposed substantially parallel to the photoreceptor 3 to form a removing-carrier collecting channel 79.

The photoreceptor 3 side of the removing-carrier collecting channel 79 is positioned closer to the photoreceptor 3 than the position B and receives the removing carrier that falls from the position B or, in other words, collects the carrier.

The removal/collecting rollers 65 deliver the collected removing carrier in a direction away from the photoreceptor 3.

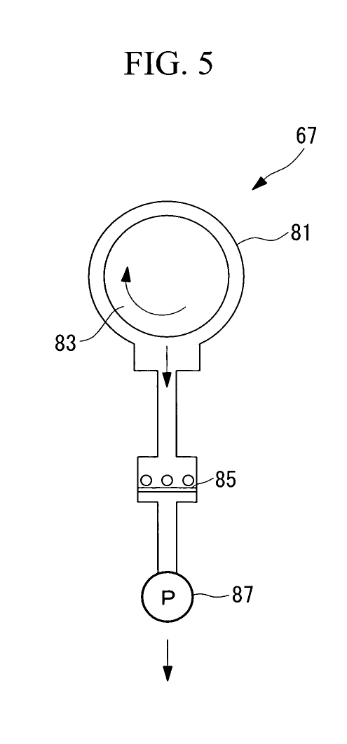

The toner separating device 67 is disposed downstream of the removing-carrier collecting channel 79 in the removing-carrier delivery direction. The toner separating device 67 is configured, for example, as shown in FIG. 5.

The toner separating device 67 includes a mesh drum 83 (constituting part of the removing-carrier collecting channel 79) that is disposed inside a sleeve 81 in a freely rotatable manner, a toner collecting filter 85, and a vacuum pump 87.

A spiral guide (not shown) is provided inside the mesh drum 83. The removing carrier collected from the toner removing roller 61 is supplied from an opening on one side in the axial direction and moves toward the other side as the mesh drum 83 rotates. While moving, the toner having a small diameter is collected at the toner collecting filter 85 through a mesh provided on the circumferential wall of the mesh drum 83 by the suction force of the vacuum pump 87. The removing carrier moves toward the other side inside the mesh drum 83.

A removing-carrier delivering device 89 is connected to the outlet of the mesh drum 83.

The removing-carrier delivering device 89 is formed of, for example, a flexible screw and has a function of delivering the removing carrier to the removing-carrier supplying channel 69.

The neutralizing device 11 is formed of LEDs arranged in the center axis direction of the photoreceptor 3 and is disposed in such a manner that the entire circumferential surface of the photoreceptor 3 is irradiated with the light emitted from the LEDs.

By irradiating the entire circumferential surface with light, the image formed by a potential difference remaining on the photoreceptor 3 after transferring the toner can be erased.

The charging device 13 comprises a corona discharger, such as a scorotron. The charging device 13 charges the entire circumferential surface of the photoreceptor 3 with a negative electrostatic charge in order to charge the photoreceptor 3 to a predetermined negative potential, e.g., approximately −1,000 V.

The exposure device 15 comprises LEDs arranged in the center axis direction of the photoreceptor 3; the LEDS are arranged so that the circumferential surface of the photoreceptor 3 is irradiated with the light emitted from the LEDs. The light emitted from the LEDs is controlled according to an image signal so as to form a prescribed image.

An electrostatic latent image is formed by a potential difference caused by the negative charge being neutralized in the regions of the photoreceptor 3 irradiated with the light.

The first intermediate body 17 is disposed substantially parallel to the photoreceptor 3 and is a drum-shaped rotary body that is supported in such a manner that it is rotatable around the center axis.

A voltage of +1,000 V is applied to the first intermediate body 17. In this way, an electric field that attracts the negatively charged toner is generated between the first intermediate body 17 and the negatively charged photoreceptor 3. In this way, toner transfer is carried out smoothly.

The cleaning device 9 comprises a fur brush 88 and a blade 90 that remove the toner remaining which is adhered on the circumferential surface of the photoreceptor 3. The fur brush 88 is made of fur and formed to scrape off the remaining toner. The blade 90 is formed of a plate-shaped resilient material, such as rubber, and is positioned in such a manner that it scrapes off the remaining toner.

The second intermediate body 19 is disposed substantially parallel to the first intermediate body 17 and is a drum-shaped rotary body that is supported in such a manner that it is rotatable around the center axis.

The second intermediate body 19 has a function of transferring the toner image transferred from the first intermediate body 17 to the glass plate G delivered through the guiding roller 21.

Next, the operation of the electrographic printing apparatus 1 having the above-described configuration will be described.

The electric potential remaining on the outer circumferential surface of the photoreceptor 3 is neutralized by the neutralizing device 11, and then an electric potential of approximately −1,000 V is applied uniformly to the entire surface by the charging device 13.

Subsequently, the outer circumferential surface charged to approximately −1,000 V is irradiated with light emitted from the exposure device 15. The electric potential in the region of the outer circumferential surface irradiated with light is reduced; the electric potential in the region is reduced to approximately −150 V.

Light emitted from the exposure device 15 is controlled on the basis of an image signal sent from a control device (not shown in the drawings) so as to form a predetermined image on the photoreceptor 3. Therefore, an electrostatic latent image that is formed by the potential difference is formed on the cylindrical surface of the photoreceptor 3.

A two-component developer, which is formed of the carrier and the toner mixed at a predetermined T/C ratio, is stored in the developing device 5. The two-component developer is stirred by the plurality of stirring/delivering rollers 27 and is delivered toward the developing roller 25 (stirring and delivering process, and stirring and delivering step).

At this time, a negative electrostatic charged is applied to the stirred toner by contact charging of the carrier, and the toner adheres to the carrier by the electrostatic force.

The two-component developer is passed from the stirring/delivering rollers 27 to the developing roller 25 before entering a supplying process or a supplying step of the present invention. The carrier to which the toner is adhered is trapped around the sleeve 41 of the developing roller 25 by a magnetic force generated by the magnetic-field forming unit 43.

The carrier trapped to the outer surface 47 of the sleeve 41 is stacked to form a shape like the ears of rice plants. Then, as the sleeve 41 rotates, the carrier to which the toner is adhered is delivered to a region opposing the photoreceptor 3.

The toner in the two-component developer that is delivered to the region opposing the photoreceptor 3 moves from the developing roller 25 to the region where the electrostatic latent image is formed on the photoreceptor 3 by the potential difference.

More specifically, since the electric potential of the cylindrical surface of the photoreceptor 3 is approximately −1,000 V and the electric potential of the electrostatic latent image is approximately −150 V, the electric potential of the developing roller 25 is approximately −800 V. Therefore, the negatively charged toner adheres only to the electrostatic latent image.

Part of the toner is transferred from the carrier, and the carrier stays attracted to the sleeve 41 and is delivered by the rotation of the sleeve 41 before entering a collection process or collection step of the present invention.

When the sleeve 41 comes near the position A, the magnetic force generated by the magnetic-field forming unit 43 is not effective. Therefore, the carrier falls into the collecting channel 39 below due to gravity.

The carrier that stays adhered to the outer surface 47 without falling is scraped off by the blade 49 and falls into the collecting channel 39 therebelow.

In this way, the carrier attracted to the outer surface 47 of the sleeve 41 can be reliably collected in the collecting channel 39.

The carrier that has fallen enters a circulating and supplying process or a circulating and supplying step of the present invention and is delivered in a direction away from the photoreceptor 3 by the collecting rollers 33.

In this way, the carrier that has a smaller toner amount as a result of toner being supplied to the photoreceptor 3 is collected in the collecting channel 39 and does not return to the supplying channel 37 untreated.

Since a fluctuation, such as a decrease, in the toner concentration near the developing roller 25 is prevented, toner can be stably transferred from the developing roller 25 to the photoreceptor 3.

The carrier delivered through the collecting channel 39 enters a toner concentration adjustment process or a toner concentration adjustment step of the present invention. In this process or step, the toner concentration, i.e., the weight ratio (T/C ratio) of the carrier and the toner, is measured by the concentration sensor 51.

The amount of toner required to achieve a predetermined value for the T/C ratio measured by the concentration sensor 51 is supplied from the toner supplying device 53.

The toner supplied by the toner supplying device 53 is stirred and delivered together with the carrier by the toner stirring/delivering rollers 55.

The carrier and the toner are delivered from the collecting channel 39 to the supplying channel 37 by the carrier delivering device 57.

In this way, the toner concentration of the carrier is adjusted to a predetermined value by the toner-concentration adjusting device 35 before being supplied to the supplying channel 37.

When delivering the carrier, the carrier delivering device 57 stirs the carrier and the toner and sufficiently charges the toner by friction so as to adhere the toner to the carrier.

In this state, the carrier is delivered to a region behind the stirring/delivering rollers 27 away from the photoreceptor 3 in the supplying channel 37. Then, the circulating and supplying process or the circulating and supplying step according to the present invention ends. The carrier is delivered toward the developing roller 25 by the plurality of stirring/delivering rollers 27.

In this way, since the carrier and the toner are stirred and delivered by the toner-concentration adjusting device 35 and the carrier delivering device 57, the toner can be sufficiently charged by contact before it is supplied to the supplying channel 37.

In this way, the toner can be reliably charged to a predetermined level.

If the toner can be sufficiently charged before being supplied to the supplying channel 37, the toner can be charged at the collecting channel 39, and the supplying channel 37 can function exclusively to uniformly supply toner in the width direction. In this way, since the functions can be separated, the development costs can be reduced by simplifying the functional design of the device.

With known development devices, the supplying channel 37 must have the two functions of charging the toner and uniformly supplying toner in the width direction. Therefore, correction is required for each toner based on repeated experiments (cut and try) on the shape, angle, pitch, rotational speed, and so on of the screw blade of the stirring/delivering rollers 27. As a result, the development costs are high, resulting in a burden in the development of large devices in small lots.

Accordingly, since the toner that has a predetermined charge level and a constant concentration is supplied from the developing device 5 to the photoreceptor 3, even when the toner is used in a wide-format apparatus, it has stable performance and is capable of forming images with a uniform film thickness.

When the toner is transferred in the developing device 5, some of the weakly charged toner detaches from the image region of the photoreceptor 3 and may slightly adhere to the non-image region.

In this embodiment, the toner that has adhered to the non-image region is removed by the non-image-region toner removing device 7, as described below.

Specifically, the removing carrier inside the removing-carrier supplying channel 69 of the non-image-region toner removing device 7 is delivered toward the toner removing roller 61 by the removing-carrier delivering rollers 63 (removing-carrier supplying process or removing-carrier supplying step).

The removing carrier that has reached the toner removing roller 61 is stacked on the outer surface 75 of the removing sleeve 71 by the magnetic force generated by the removing-magnetic-force forming unit 73 and the magnetic brush is formed. Then the carrier enters the removing process or the removing step of the present invention.

An electric potential is applied to the toner removing roller 61 so as to generate, for example, an electric field in the same direction as the electric field generated between the first intermediate body 17 and the photoreceptor 3 (in this embodiment, an electric field that moves the negatively charged toner to the first intermediate body 17 is generated).

The base fogging toner adhered to the non-image region is a weakly charged toner and is a mixture of a toner with a weak positive charge, a toner with zero charge, and a toner with a weak negative charge.

When an intermediate charge between that of the non-image region and the image region of the photoreceptor 3 is applied to the toner removing roller 61, in the non-image region, a force due to an electric field acts to move the negatively charged toner from the non-image region to the toner removing roller 61, whereas in the image region, a force due to an electric field acts to move the negatively charged toner, which is the image toner, toward the photoreceptor 3.

The acting force causes the negatively charged toner of the base fogging toner in the non-image region to be electrically attracted to the magnetic brush, i.e., removing carrier.

Consequently, after moving through the toner removing roller 61, the toner having zero charge and the positively charged toner remain in the non-image region.

The removing carrier continues to be attracted by the removing sleeve 71, is delivered by the rotation of the removing sleeve 71, and enters the removing-carrier collecting process or the removing-carrier collecting step of the present invention.

When the removing sleeve 71 moves close to the position B, the magnetic force generated by the removing-magnetic-force forming unit 73 is not affected. Therefore, the removing carrier falls into the removing-carrier collecting channel 79 below due to gravity.

The removing carrier that stays adhered to the outer surface 75 without falling is scraped off by the removing blade 77 and falls into the removing-carrier collecting channel 79 below.

In this way, the removing carrier attracted to the outer surface 75 of the removing sleeve 71 can be reliably collected in the removing-carrier collecting channel 79.

The removing carrier that has fallen enters the removing-carrier circulating and supplying process or the removing-carrier circulating and supplying process of the present invention and is delivered in a direction away from the photoreceptor 3 by the removal/collecting rollers 65.

The removing carrier delivered through the removing-carrier collecting channel 79 is guided to the toner separating device 67 (carrier cleaning process or carrier cleaning step).

At the toner separating device 67, the base fogging toner adhered to the removing carrier is sucked and separated by the vacuum pump 87. The separated base fogging toner is collected by the toner collecting filter 85 through a mesh provided in the circumferential wall of the mesh drum 83.

The removing carrier from which the base fogging toner has been separated is supplied from the removing-carrier collecting channel 79 to the removing-carrier supplying channel 69 by the removing-carrier delivering device 89 (end of the removing-carrier circulating and supplying process or removing-carrier circulating and supplying step) and is circulated for reuse.

In this way, after the base fogging toner adhered to the removing carrier is removed by the toner separating device 67, the removing carrier is circulated and supplied through the removing-carrier supplying channel 69. Therefore, the removing carrier, without having the base fogging toner attached thereto, approaches the photoreceptor 3 and the toner is reliably prevented from being transferred onto the photoreceptor 3 again from the removing carrier.

In this way, since stable and reliable removal of the base fogging toner is possible, the printing quality can be improved.

Next, the toner adhered to the latent image on the photoreceptor 3 is delivered to a region opposing the first intermediate body 17, which is an exemplary transfer receiving body, by the rotation of the photoreceptor 3.

To transfer the toner in the image region, an electric field for transferring (moving) the negatively charged toner to the first intermediate body 17 is applied to the first intermediate body 17.

Since this electric field causes the toner in the image region to be transferred to the first intermediate body 17 and generates a force pushing toward the photoreceptor 3 to act upon the positively charged toner in the base fogging region, transfer of the toner to the first intermediate body 17 is prevented or decreased.

After the toner is transferred, the remaining toner on the photoreceptor 3 that is not transferred is removed by the cleaning device 9. More specifically, the fur brush 17 scrapes off the remaining toner, and then the blade 19 scrapes off the remaining toner. Subsequently, the latent image remaining on the photoreceptor 3 is erased by the neutralizing device 11.

The toner adhered to the first intermediate body 17 is delivered to a region opposing the second intermediate body 17 by the rotation of the first intermediate body 17.

Here, the toner is transferred to the second intermediate body 19.

Then, by the rotation of the second intermediate body 19, the toner reaches a region opposing the glass plate G being delivered between the second intermediate body 19 and the guiding roller 21 and is transferred onto the glass plate G.

If a ceramic plate is delivered instead of the glass plate G, printing is possible on the ceramic plate.

The toner transferred onto the glass plate G is heated and fired in post-processing and is attached to the glass plate G with glass powder functioning as an adhesive. Since the toner contains conductive silver powder, for example, wires for defogging can be formed on the glass plate G by transferring a predetermined toner pattern.

In this embodiment, the supplying channel 37 of the developing device 5 is formed two-dimensionally, but it is not limited thereto.

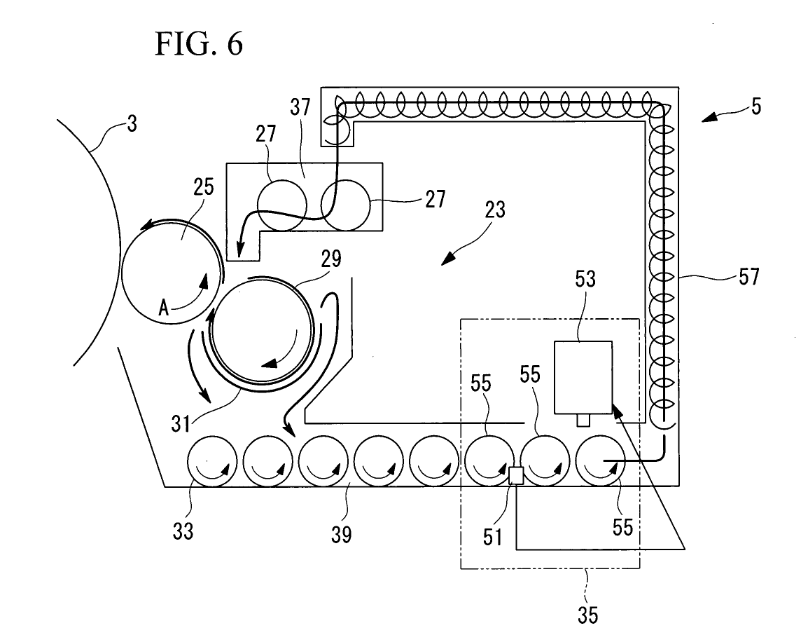

For example, as shown in FIG. 6, the supplying channel 37 may be divided into upper and lower sections.

In other words, a supplying roller 29 may be disposed adjacent to the developing roller 25, and, for example, two stirring/delivering rollers 27, disposed parallel to each other, may be disposed above the supplying roller 29.

The carrier stirred and delivered by the stirring/delivering rollers 27 falls on the upper section of the supplying roller 29 on the photoreceptor 3 side. This section moves away from the photoreceptor 3 as the supplying roller 29 rotates and is delivered to the developing roller 25. A cover 31 that covers the lower section of the supplying roller 29 is provided, and the carrier that does not enter between the supplying roller 29 and the cover 31 falls into the collecting channel.

In this way, since the height of the developing device 5 increases on the photoreceptor 3 side (front) and decreases on the back side, the orientation of the device can be selected accordingly.

In this embodiment, the supplying channel 37 is disposed in the upper section, and the collecting channel 39 is disposed in the lower section, but it is not limited thereto.

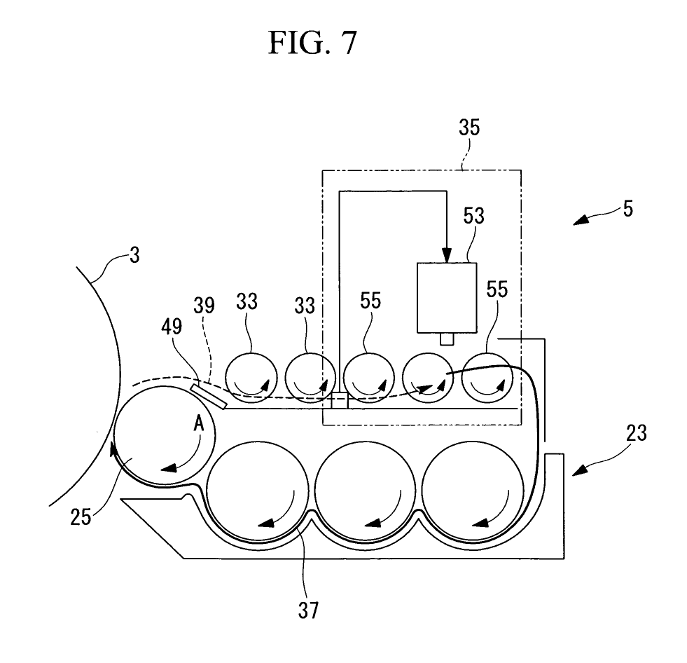

For example, when the rotation direction of the developing roller 25 is clockwise, the supplying channel 37 is disposed in the lower section and the collecting channel 39 is disposed in the upper section, as shown in FIG. 7.

In this way, the carrier is delivered from the collecting channel 39 to the supplying channel 37 merely by falling. Therefore, the delivery is easy, and the structure is simplified.

Moreover, since the carrier delivering device 57 is not required, less stress is applied to the toner, and a decrease in the durability of the toner can be prevented.

In this embodiment, the collecting channel 39 is integrated into a single unit in the width direction. However, it is not limited thereto, and the collecting channel 39 may be divided in the width direction.

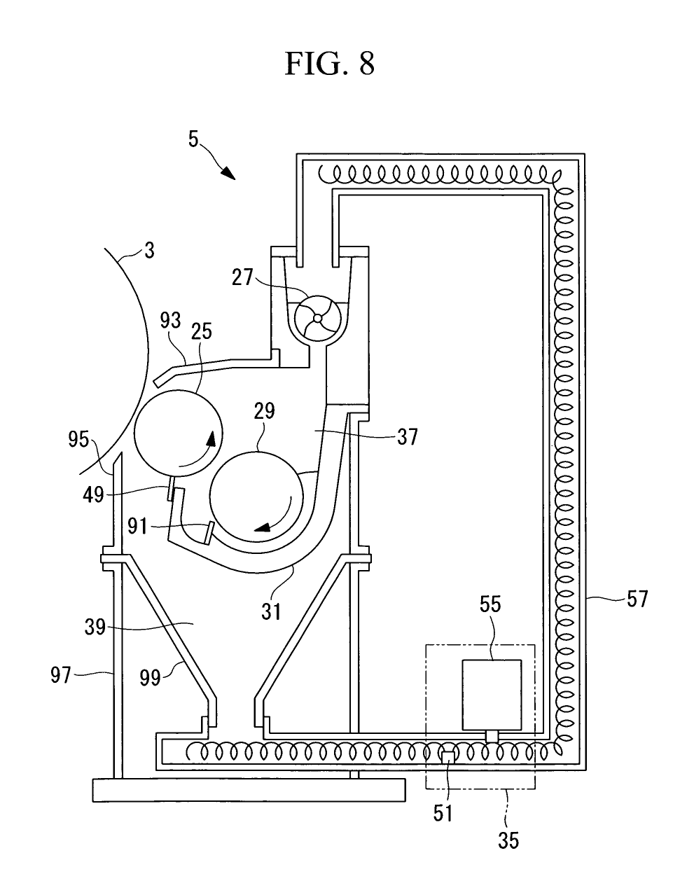

As an example of the collecting channel 39 divided in such a manner will be described with reference to FIGS. 8 to 11.

The supplying channel 37 is configured in substantially the same manner as that shown in FIG. 6.

The supplying channel 37 includes a cover 31 having a substantially J-shaped cross-section. The developing roller 25 is disposed at the tip of the hook of the letter J; the supplying roller 29 is disposed inside the hook of the letter J; and the stirring/delivering rollers 27 are disposed above the letter J.

The stirring/delivering rollers 27 are each formed in the shape of a screw in order to transfer the carrier in the width direction. The gaps between the stirring/delivering rollers 27 and the adjacent walls are set to a size that prevents the carrier which supplied from above from falling in a clump.

The carrier is supplied from below the stirring/delivering rollers 27, through the inner side of the cover 31, to behind the supplying roller 29.

The supplying roller 29 is formed to supply the carrier to the developing roller 25 through the section below the supplying roller 29. A restriction blade 91 for restricting the supplied amount is attached to the inner side of the cover 31.

An upper cover 93 for preventing spattering of the toner is provided above the developing roller 25.

The collecting channel 39 includes a base 97 and a plurality of (for example, four) collecting containers 99.

The base 97 is a substantially rectangular box with an opening at the top. Three bars 101 are provided parallel to the shorter side of the opening of the base 97.

The collecting containers 99 are boxes each formed by placing a cylinder on a quadrangular pyramid, with openings at the upper and lower ends.

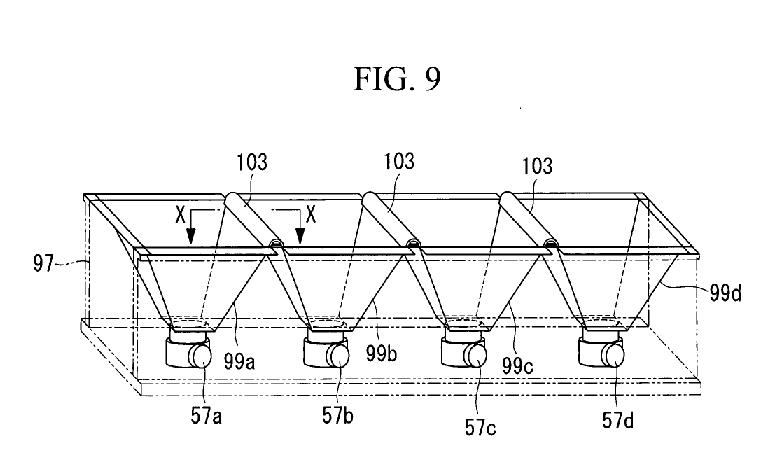

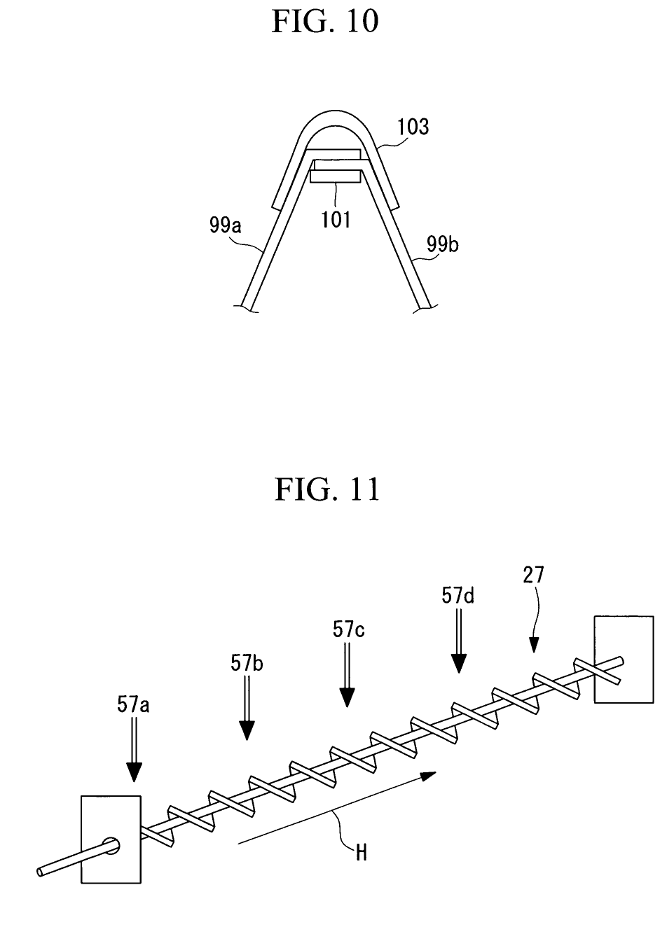

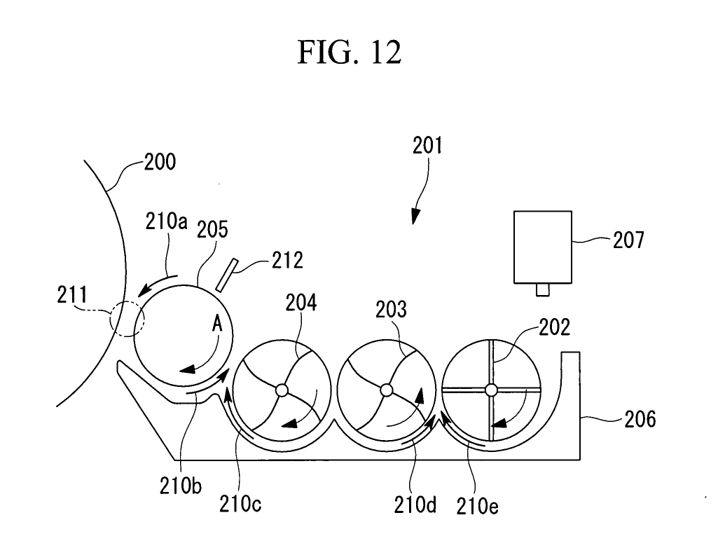

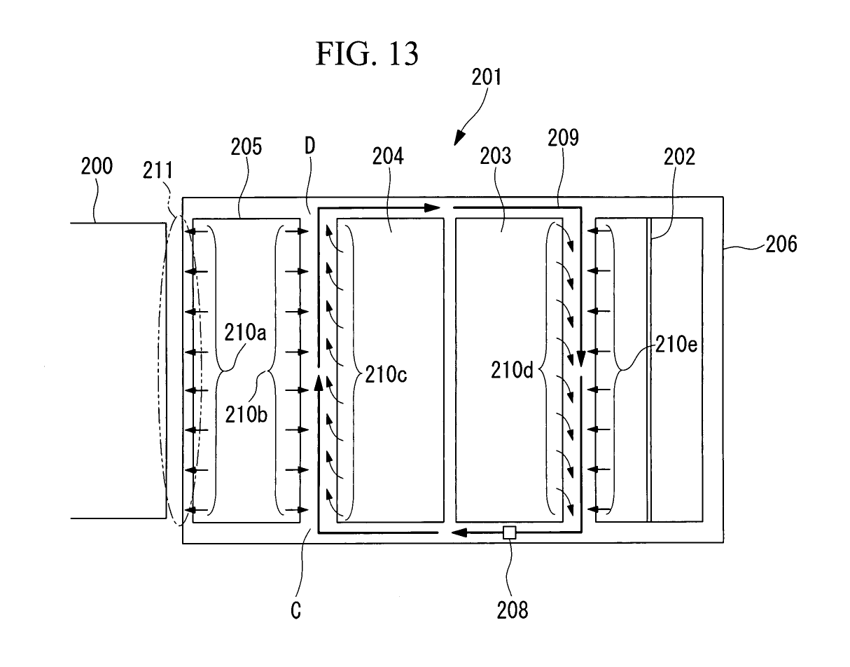

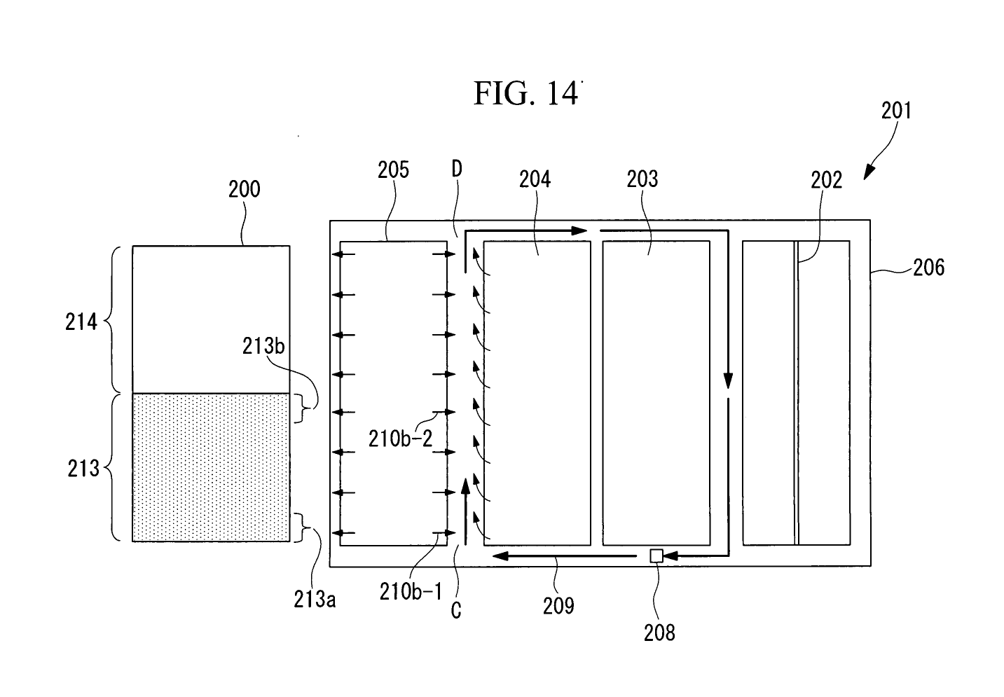

The collecting containers 99 are fixed by placing the small-diameter cylindrical portion facing downward and mounting the upper protrusion to the side of the base 97 and the bars 101 (see FIGS. 9 and 10).

On the upper portion of the collecting containers 99 on the photoreceptor 3 side, a protection cover 95 for preventing spattering of the collected carrier is attached in such a manner that it extends upward.

As shown in FIG. 10, adjacent collecting containers 99 overlap each other at the bars 101. At the upper portion of this overlap, a cap 103 having a hyperbolic cross-section is provided to prevent the carrier from accumulating.

Carrier delivering devices 57, which are formed of, for example, flexible screws, are attached to the cylindrical portion.

The carrier delivering devices 57 are formed to deliver the collected carrier to the region above the stirring/delivering rollers 27.

A toner-concentration adjusting device 35 is mounted in the region upstream of the stirring/delivering rollers 27.

When the carrier is delivered along the axis in the delivery direction H by the rotation of the stirring/delivering rollers 27, as shown in FIG. 11, the supplying positions of the four sets of carrier delivering devices 57a, 57b, 57c, and 57d supply the carrier to the stirring/delivering rollers 27 in such a manner that the carrier delivering device 57a supplies to substantially one end of the stirring/delivering rollers 27 and the carrier delivering devices 57b, 57c, and 57d supply to respective positions that divide the length from the carrier delivering device 57a to the other end into three sections.

In this way, the amount of carrier supplied by falling from the stirring/delivering rollers 27 can be substantially evened out in the width direction.

The carrier that has transferred part of the toner is delivered in this state by the developing roller 25 and falls into the collecting channel 39 below near the position A due to gravity because the magnetic force generated by the magnetic-field forming unit 43 weakens.

The carrier that continues to adhere to the outer surface 47 without falling is rubbed off by the blade 49 and falls into the collecting channel 39 below.

The carrier that has fallen is guided to the walls of the collecting containers 99a, 99b, 99c, and 99d, which are disposed at corresponding positions, and is guided to the carrier delivering devices 57a, 57b, 57c, and 57d.

The carrier that falls onto the edges of adjacent collecting containers 99 is guided to one of the collecting containers 99 by the caps 103.

The toner concentration, i.e., the carrier to toner weight ratio (T/C ratio), of the carrier delivered through the carrier delivering devices 57 is measured by the concentration sensor 51.

An amount of toner required for the T/C ratio measured by the concentration sensor 51 to reach a predetermined value is supplied from the toner supplying device 53.

The toner supplied by the toner supplying device 53 is stirred and delivered together with the carrier by the carrier delivering devices 57.

In this way, the toner concentration of the carrier is adjusted to a predetermined value by the toner-concentration adjusting device 35, and the toner is supplied to the stirring/delivering rollers 27 with sufficient charge level.

Accordingly, the following advantages are also achieved in addition to the advantages achieved in this embodiment.

Specifically, since the collecting channel 39 is divided into a plurality of sections in the width direction and a toner-concentration adjusting device 35 is provided for each divided section, the extent of the range to be adjusted by each toner-concentration adjusting device 35 is reduced, and the accuracy of concentration adjustment can be improved.

In this way, since toner having an even more uniform concentration is supplied from the developing device 5 to the photoreceptor 3, stable performance is achieved, and the printing quality is improved.

Since the toner is stirred and delivered in each divided section, stress applied to the toner is reduced, and the durability of the toner can be improved.

In other words, when a large amount of toner is delivered through a single channel, toner is placed on top of other toner, causing the toner in the lower layer to be compressed and condensed. As a result, degradation of the toner over time, such as a decrease in the fluidity of toner, tends to occur. However, by dividing the sections according to the width of the developing device 5, the delivery amount can be set constant, and even when the width of the developing device 5 is large, the durability of the toner can be maintained at a level equivalent to that of a developing device 5 having a small width, thus simplifying design and making it easy to maintain durability.

By setting the size of the divided sections to a standard size, the design and development costs of the apparatus using common parts can be reduced by producing an apparatus having a width that is the integral multiple of the standard size.

Moreover, in this embodiment, the developing device 5 and the non-image-region toner removing device 7 both supply the carrier or the removing carrier through a single path. In other words, in the developing device 5, the carrier that has supplied the toner to the photoreceptor 3 is circulated and supplied to the supplying channel 37 after being supplied with toner. In the non-image-region toner removing device 7, the toner adhered to the removing carrier is removed by cleaning, and the carrier is reused. However, depending on the conditions, such a configuration may be applied to one of the devices.

The present invention is not limited to the above-described embodiments, and various modifications may be made within the scope of the present invention.

For example, in the configuration according to the above-described embodiments, toner containing silver powder is transferred onto a glass plate. However, the configuration is not limited thereto, and toner containing various other materials may be transferred onto another material.

1. A developing device for an electrographic printing apparatus comprising:
a supplying channel having at least one delivering roller for stirring and delivering a carrier and a toner charged by contacting the carrier;
a developing member for supplying the toner adhered to the carrier to a supplying position of an electrostatic latent image on a photoreceptor, the developing member being disposed on the photoreceptor side of the supplying channel and having a supplying surface that moves circumferentially and attracts the carriers;
a collecting unit for collecting the carrier from the supplying surface at a position downstream of the supplying position in the moving direction of the supplying surface;
a collecting channel for delivering the carrier collected at the collecting unit and circulating and supplying the carrier to the supplying channel; and
a toner-concentration adjusting device, provided in the collecting channel, for adjusting the ratio of the carrier and the toner delivered through the collecting channel to a predetermined value.

2. The developing device for the electrographic printing apparatus according to claim 1, wherein the carrier and the toner are stirred while being delivered through the collecting channel.

3. The developing device for the electrographic printing apparatus according to claim 1, wherein the collecting unit includes a blade for rubbing off the carrier, the blade being in contact with the supplying surface.

4. The developing device for the electrographic printing apparatus according to claim 1, wherein the toner-concentration adjusting device includes a toner-concentration measuring device for measuring the toner concentration and a toner supplying device for supplying the toner.

5. The developing device for the electrographic printing apparatus according to claim 1, wherein the collecting channel is divided into a plurality of sections in the width direction.

6. A non-image-region toner removing device of an electrographic printing apparatus, comprising:
a removing-carrier supplying channel for delivering a removing carrier, the removing-carrier supplying channel being provided downstream of a developing device for supplying a toner to an electrostatic latent image forming an image region on a photoreceptor;
a removing member for removing a toner adhered to a non-image region on the photoreceptor at a removing position using the removing carrier, the removing member being disposed on the photoreceptor side of the removing-carrier supplying channel and having a removing surface that moves circumferentially and attracts the removing carrier;
a removing-carrier collecting unit for collecting the removing carrier from the removing surface at a position downstream of the removing position in the moving direction of the removing surface;
a removing-carrier collecting channel for delivering the removing carrier collected at the removing-carrier collecting unit and circulating and supplying the removing carrier to the removing-carrier supplying channel; and
a carrier cleaning unit, provided in the removing-carrier collecting channel, for removing the toner from the removing carrier delivered through the removing-carrier collecting channel.

7. The non-image-region toner removing device of the electrographic printing apparatus according to claim 6, wherein the removing-carrier collecting unit includes a removing blade for rubbing off the removing carrier, the removing blade being in contact with the removing surface.

8. An electrographic printing apparatus using the developing device according to claim 1.

9. An electrographic printing apparatus using the non-image-region toner removing device according to claim 6.

10. An electrographic printing apparatus using the developing device according to claim 1 and the non-image-region toner removing device according to claim 6.

11. An electrographic printing method comprising:
a stirring and delivering step of stirring and delivering a carrier and a toner charged by contacting the carrier using at least one delivering roller;
a supplying step of attracting the carrier delivered in the stirring and delivering step and supplying the toner adhered to the carrier to a supplying position of an electrostatic latent image on a photoreceptor using a developing member having a supplying surface that moves circumferentially;
a collecting step of collecting the carrier from the supplying surface at a position downstream of the supplying portion in the moving direction of the supplying surface;
a circulating and supplying step of delivering the carrier collected in the collecting step and circulating and supplying the carrier to the supplying channel; and
a toner-concentration adjusting step of adjusting the ratio of the carrier and the toner delivered in the circulating and supplying step to a predetermined value.

12. A method of producing a glass plate or a ceramic plate by forming a pattern on the glass plate or the ceramic plate using an electrographic printing apparatus involving a stirring and delivering step of stirring and delivering a carrier and a toner charged by contacting the carrier using at least one delivering roller, and a supplying step of attracting the carrier delivered in the stirring and delivering step and supplying the toner adhered to the carrier to a supplying position of an electrostatic latent image on a photoreceptor using a developing member having a supplying surface that moves circumferentially, the method of producing a glass plate or a ceramic plate comprising:
a collecting step of collecting the carrier that passed the supplying position from the supplying surface;
a circulating and supplying step of delivering the carrier collected in the collecting step and circulating and supplying the carrier to the supplying channel; and
a toner-concentration adjusting step of adjusting the ratio of the carrier and the toner delivered in the circulating and supplying step to a predetermined value.

13. An electrographic printing method comprising:
a removing-carrier supplying step of delivering a removing carrier downstream of a developing device for supplying a toner to an electrostatic latent image forming an image region on a photoreceptor;
a removing step of attracting the removing carrier delivered in the removing-carrier supplying step with a removing member having a removing surface that moves circumferentially and removing a toner adhered to a non-image region of the photoreceptor at a removing position using the removing carrier;
a removing-carrier collecting step of collecting the removing carrier that passed the removing position from the removing surface;
a removing-carrier circulating and supplying step of delivering the removing carrier collected in the removing-carrier collecting step and circulating and supplying the removing carrier to the removing-carrier supplying channel; and
a carrier cleaning step of removing the toner from the removing carrier delivered in the removing-carrier circulating and supplying step.

14. A method of producing a glass plate or a ceramic plate by forming a pattern on the glass plate or the ceramic plate using an electrographic printing apparatus involving a removing-carrier supplying step of delivering a removing carrier downstream of a developing device for supplying a toner to an electrostatic latent image forming an image region on a photoreceptor, and a removing step of attracting the removing carrier delivered in the removing-carrier supplying step with a removing member having a removing surface that moves circumferentially and removing a toner adhered to a non-image region of the photoreceptor at a removing position using the removing carrier, the method of producing a glass plate or a ceramic plate comprising:
a removing-carrier collecting step of collecting the removing carrier that passed the removing position from the removing surface;
a removing-carrier circulating and supplying step of delivering the removing carrier collected in the removing-carrier collecting step and circulating and supplying the removing carrier to the removing-carrier supplying channel; and
a carrier cleaning step of removing the toner from the removing carrier delivered in the removing-carrier circulating and supplying step.
